(19) United States
(12) Patent Application Publication
(10) Pub. No.: US 2024/0375267 A1
(43) Pub. Date: Nov. 14, 2024

(54) EXOSKELETON AND METHOD

(71) Applicant: FESTOOL GMBH, Wendlingen (DE)

(72) Inventors: Jan HAMMER, Elchingen (DE); Andreas ARGUBI-WOLLESEN, Hamburg (DE); Bernward OTTEN, Hamburg (DE); Robert WEIDNER, Bohlsen (DE); Mauritz FETHKE, Hamburg (DE); Esther HOLSTEN-STUEHMER, Hamburg (DE)

(21) Appl. No.: 18/682,377

(22) PCT Filed: Aug. 12, 2022
(86) PCT No.: PCT/EP2022/072718

§ 371 Date: Feb. 8, 2024

(30) Foreign Application Priority Data
Aug. 13, 2021 (DE) 10 2021 208 909.7

(51) Int. Cl. B25J 9/00

(52) U.S. Cl. CPC B25J 9/0006

(57) ABSTRACT

An exoskeleton, including a base section for attachment to a body section, in particular the torso, of the human body, a support section movably coupled to the base section for supporting a body part, preferably a limb, in particular an arm, of the human body, an actuator device, in particular a pneumatic actuator device, acting on the support section for providing a support force for the body part. The base section has a main section and a textile carrying system with which the base section can be attached to the body section. Alternatively, the support section has a main section and a textile carrying system with which the support section can be attached to the body part, namely a back of the human body. The exoskeleton further includes a carrying system attachment interface with which the textile carrying system is releasably attached to the main section.

The invention relates to an exoskeleton comprising: a base section for attachment to a body section, in particular the torso and/or extremities, of the human body, a support section movably coupled to the base section for supporting a body part, preferably a limb, in particular an arm, of the human body and an actuator device, in particular pneumatic, electrical and/or mechanical, acting on the support section for providing a support force for the body part, in particular the limb.

Exoskeletons are known from U.S. Pat. Nos. 10,864,102B2, 10,918,559B2 and 10,165,847B2.

It is an object of the invention to provide an exoskeleton that can be used flexibly.

The object is solved by an exoskeleton according to claim 1. The base section of the exoskeleton has a main section and a textile carrying system with which the base section is attachable to the body section. Alternatively, the support section comprises a main section and a textile carrying system with which the support section is attachable to the body section, namely a back of the human body. The exoskeleton further comprises a carrying system attachment interface with which the textile carrying system is attached to the main section in a in particular tool-free detachable manner.

The textile carrying system comprises in particular a back mesh, one or two shoulder straps and/or a pelvic strap. The carrying system attachment interface is designed as a quick-release system, for example. The carrying system attachment interface enables the textile components of the exoskeleton to be separated from the rest of the exoskeleton, which is also to be referred to as the exoskeleton main part. This makes it easy to use the exoskeleton main part with different textile carrying systems, in particular those adapted to different conditions of use and/or different users. Furthermore, the textile carrying system can be easily removed from the exoskeleton main part in case the textile carrying system becomes soiled and can be washed, for example. The exoskeleton can therefore be used flexibly.

Advantageous further developments are the subject of the dependent claims.

The invention further relates to a method according to claim 17 and a method according to claim 18.

Further exemplary details and exemplary embodiments are explained below with reference to the figures. Thereby shows

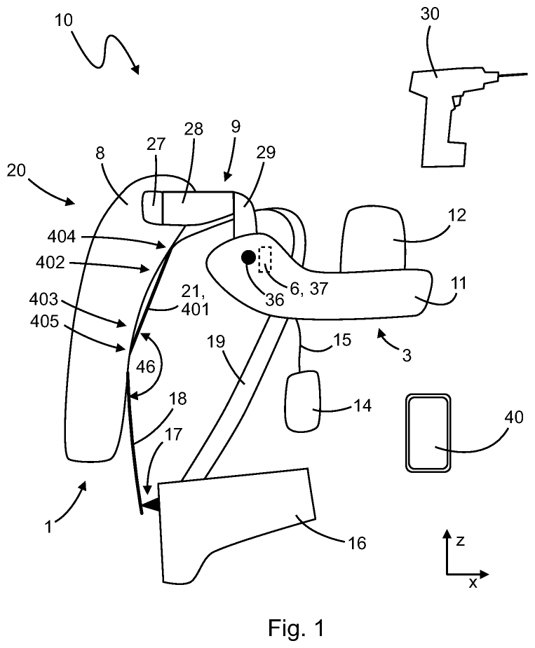

FIG. 1 a schematic side view of an exoskeleton device,

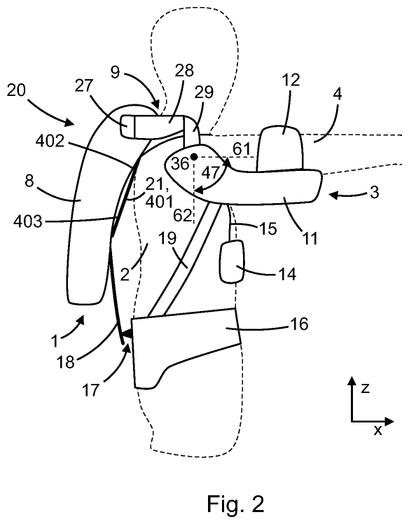

FIG. 2 a schematic side view of an exoskeleton worn by a user,

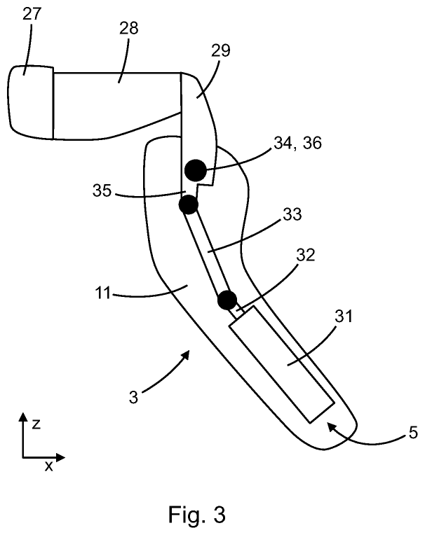

FIG. 3 a schematic detailed view of a support section of the exoskeleton,

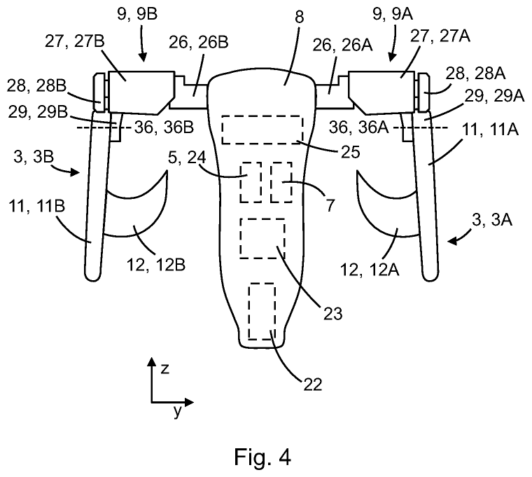

FIG. 4 a schematic rear view of the exoskeleton,

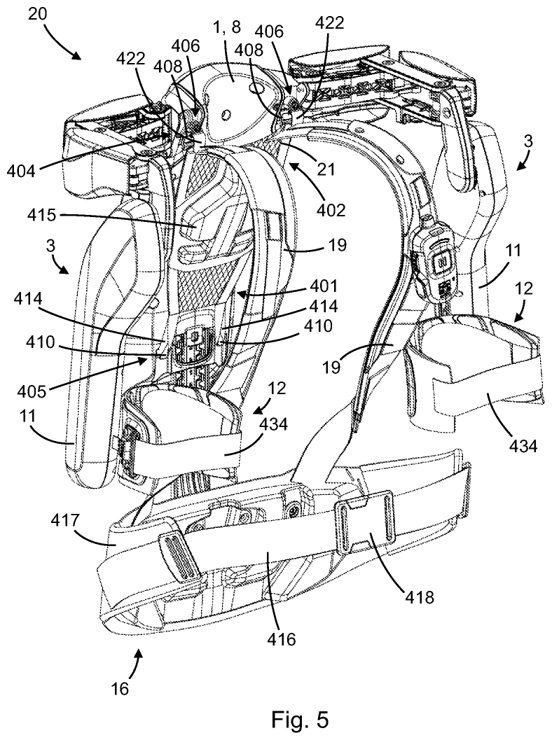

FIG. 5 a perspective view of an exemplary embodiment of the exoskeleton,

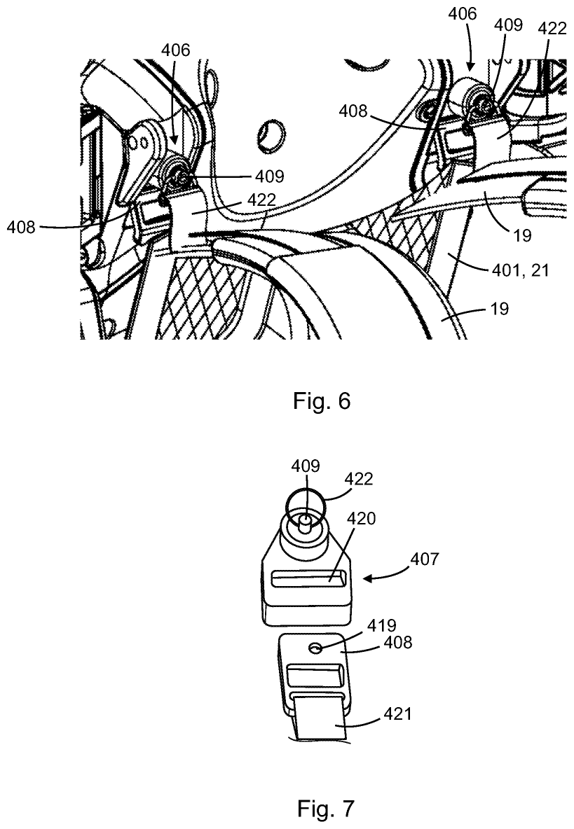

FIG. 6 an enlarged view of an upper attachment point shown in FIG. 5,

FIG. 7 a safety fastening device,

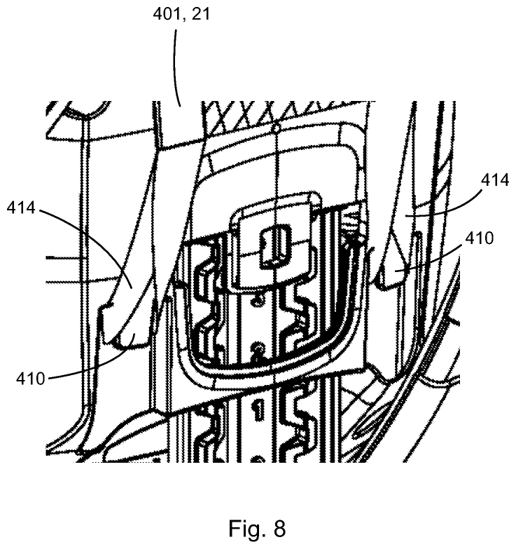

FIG. 8 an enlarged view of a lower attachment point shown in FIG. 5,

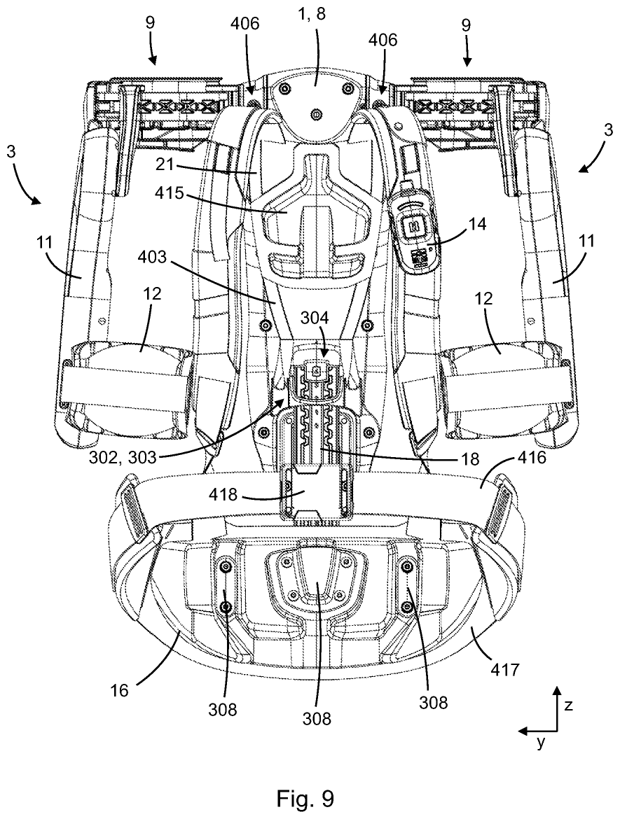

FIG. 9 a front view of the exemplary embodiment of the exoskeleton,

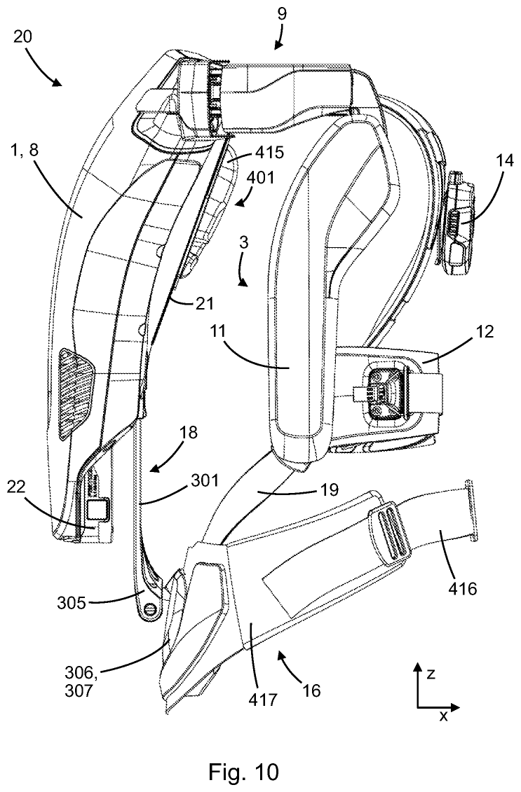

FIG. 10 a side view of the exemplary embodiment of the exoskeleton,

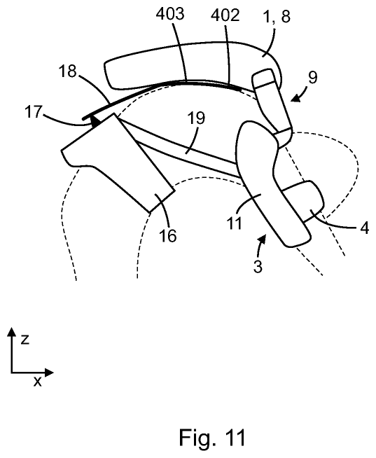

FIG. 11 a schematic side view of the exoskeleton worn by the user, with the user in a forward bent posture,

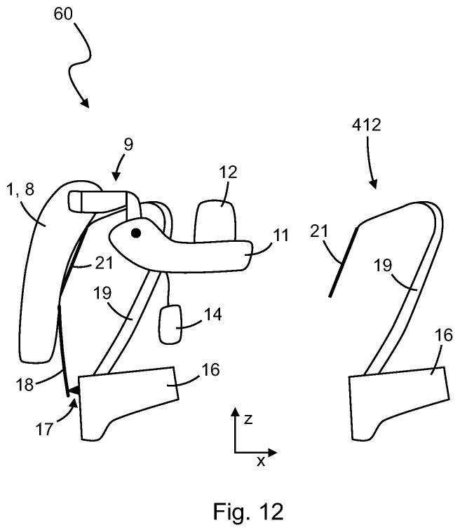

FIG. 12 an arrangement with an exoskeleton and a second textile carrying system,

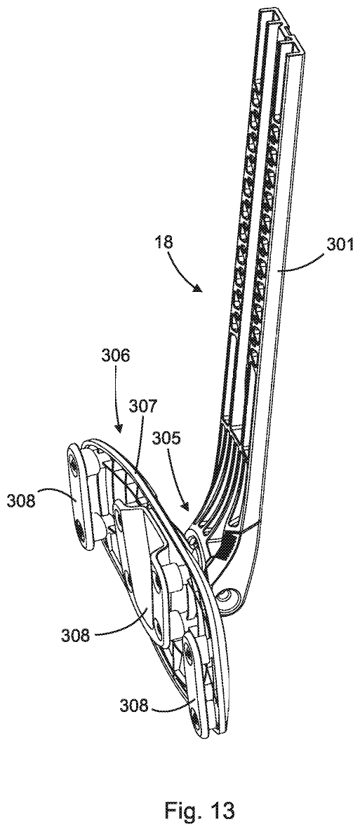

FIG. 13 a perspective view of a joint fastening device,

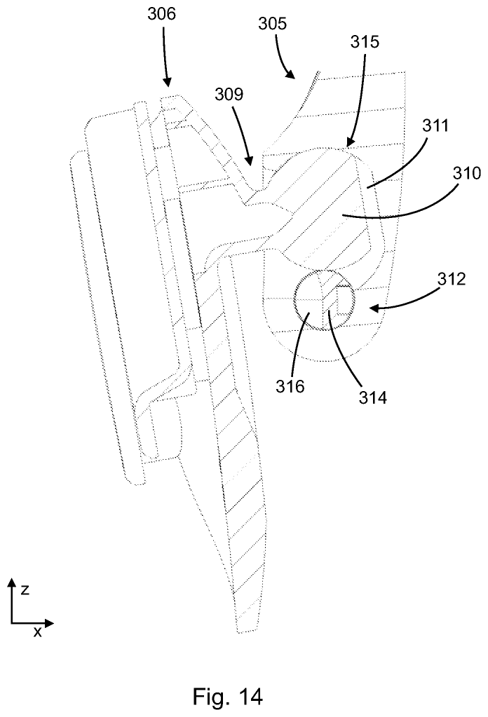

FIG. 14 a first section through the joint fastening device,

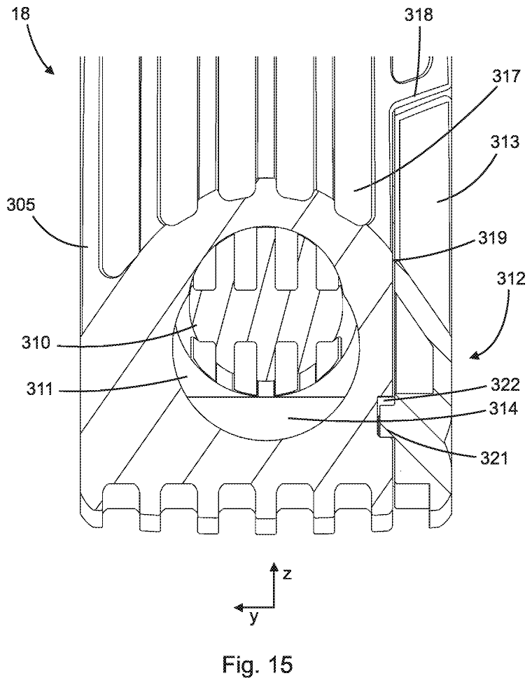

FIG. 15 a second section through the joint fastening device,

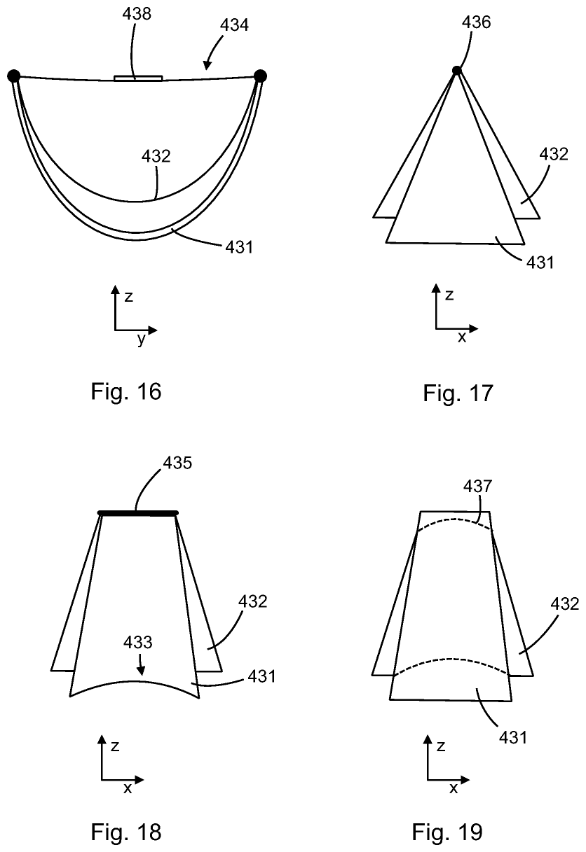

FIG. 16 a schematic front view of an arm attachment,

FIG. 17 a schematic side view of an arm attachment according to a first variant,

FIG. 18 a schematic side view of an arm attachment according to a second variant,

FIG. 19 a schematic side view of an arm attachment according to a third variant

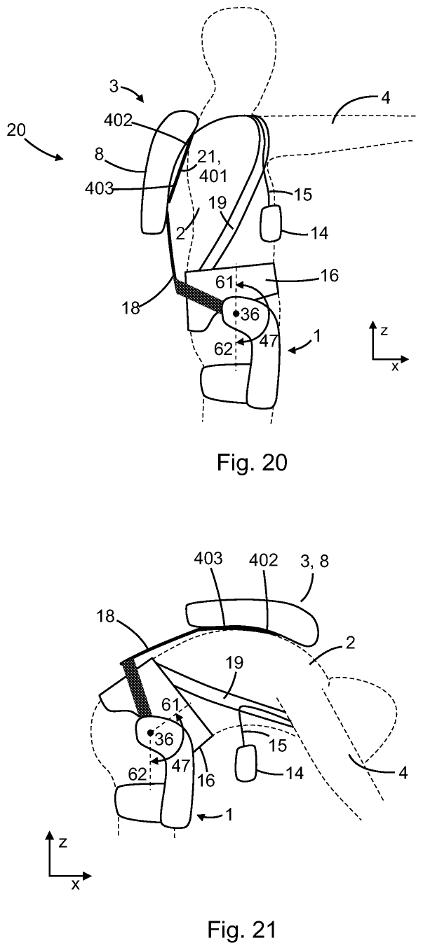

FIG. 20 an exoskeleton according to a second embodiment, and

FIG. 21 the exoskeleton according to the second embodiment.

In the following explanations, reference is made to the spatial directions x-direction, y-direction and z-direction, which are drawn in the figures and are aligned orthogonally to each other. The z-direction can also be referred to as the vertical direction, the x-direction as the depth direction and the y-direction as the width direction.

FIG. 1 shows a schematic representation of an exoskeleton device 10 comprising an exoskeleton 20 and optionally a tool 30 and/or a mobile device 40. The exoskeleton 20 can also be provided on its own. The tool 30 and/or the mobile device 40 are exemplarily provided separately from the exoskeleton 20, i.e. in particular not mechanically connected to the exoskeleton 20. The tool 30 is, for example, a power tool, in particular a cordless screwdriver and/or a drill and/or a grinder. The mobile device 40 is preferably a smartphone or a tablet. Optionally, the exoskeleton 20 is configured to communicate with the tool 30 and/or the mobile device 40, in particular wirelessly.

As an example, the exoskeleton 20 is aligned in an upright orientation with its vertical axis (which in particular runs parallel to a base section axis 62) parallel to the z-direction. In particular, the exoskeleton 20 is aligned in the upright orientation with its sagittal axis parallel to the x-direction. In a state in which the user has put on the exoskeleton 20, the sagittal axis of the exoskeleton 20 runs parallel to the sagittal axis of the user, i.e. in particular parallel to a direction from the rear—i.e. in particular the back of the user—to the front—i.e. in particular the chest of the user. The horizontal axis of the exoskeleton 20 runs in particular in the width direction of the exoskeleton 20 and/or parallel to the y-direction. In a state in which the user has put on the exoskeleton 20, the horizontal axis of the exoskeleton 20 runs parallel to the horizontal axis of the user, i.e. in particular parallel to a direction from a first shoulder of the user to a second shoulder of the user. The vertical axis of the exoskeleton 20, the sagittal axis of the exoskeleton 20 and the horizontal axis of the exoskeleton 20 are aligned orthogonally to each other.

The exoskeleton device 10 is designed in particular for manual and/or industrial use. Preferably, the exoskeleton device 10 is not designed for medical and/or therapeutic use.

The exoskeleton 20 is an active exoskeleton and in particular has an internal energy source from which the energy for the support force is provided. In particular, the exoskeleton 20 is an active exoskeleton for actively supporting a body part, for example the shoulder joint, of the user.

The exoskeleton 20 comprises a base section 1 for attachment to a body section of a human body of a user. By way of example, the base section 1 serves to be attached to the torso 2 of the human body.

The base section 1 comprises a main section and a textile carrying system, which is in particular detachably attached to the main section. By way of example, the main section serves to be worn on the back of the human body by means of the textile carrying system, in particular in a backpack-like manner. The main section comprises a back part 8, which is in particular elongated and which is expediently aligned with its longitudinal axis vertically and/or in the longitudinal direction of the user's back. For example, the longitudinal direction of the back part 8 extends along the longitudinal direction of the back. The main section further comprises a force transmission element 18, which is in particular strip-shaped and/or rigid and extends downwards from the back part 8 to a pelvic strap 16 in order to mechanically couple the back part 8 to the pelvic strap 16. The force transmission element 18 is expediently used to transmit a reaction force, which is transmitted from a support section 3 to the back part 8, further to the pelvic strap 16. As an example, the back part 8 is tubular and/or backpack-shaped. The back part 8 is in 5 particular rigid. In particular, the back part 8 comprises an expediently rigid back part housing, which is made, for example, from an in particular rigid plastic and/or as a hard shell. The back part 8 expediently serves to transmit a force from the support section 3 to the force transmission element 18 and/or to accommodate components for controlling the support force.

The support section 3 can expediently be referred to as an arm actuator.

The force transmission element 18 is exemplarily sword-shaped and can also be referred to as a sword. Expediently, the force transmission element 18 is designed to be adjustable relative to the back part 8, in particular in order to change the vertical extent of the main section and/or a force transmission element angle 46 between the force transmission element 18 and the back part 8 facing the user's back. Expediently, the force transmission element 18 is mounted for translational and/or rotational movement relative to the back part 8 and, in particular, can be moved into various translational and/or rotational positions relative to the back part 8 and, in particular, can be locked. The translational movement is in particular vertical. The rotational movement is expediently performed about an adjustment axis aligned parallel to the y-direction.

The textile carrying system comprises, by way of example, the pelvic strap 16 and/or at least one, preferably two, shoulder straps 19. The pelvic strap 16 expediently forms a loop so that, when worn, it surrounds the torso 2, in particular the hips, of the user. Each shoulder strap 19 extends exemplarily from the main section, in particular from the back part 8, to the pelvic strap 16, expediently over a respective shoulder of the user when the exoskeleton 20 is worn.

The exoskeleton 20 further comprises, by way of example, a force transmission element joint 17, via which the force transmission element 18 is attached to the pelvic strap 16.

The force transmission element joint 17 is designed, for example, as a ball joint and can be referred to as a sacral joint. When the exoskeleton 20 is worn, the force transmission element joint 17 is arranged in the lower back region of the user, in particular centered in the width direction.

By way of example, the textile carrying system also comprises a back mesh 21, which is arranged on the side of the back part 8 facing the user's back. When the exoskeleton 20 is worn, the back mesh 21 lies against the user's back, in particular at least partially and/or in the upper back region.

The exoskeleton 20 further comprises the support section 3 movably coupled to the base section 1 for supporting a body part, preferably a limb, in particular an arm 4, of the human body of the user. In particular, the support section 3 is designed to be attached to the body part, preferably the limb, in particular the arm 4, of the user. The support section 3 comprises, by way of example, an in particular rigid arm part 11 and an arm attachment 12 arranged on the arm part 11, which is designed, by way of example, as an arm shell. The arm part 11 is exemplarily elongated and, when worn, is aligned with its longitudinal axis in the direction of the longitudinal axis of the user's arm. As an example, the arm part 11 extends from the shoulder of the user to the elbow area of the user. The exoskeleton 20, in particular the arm part 11, ends at the elbow area of the user. The arm attachment 12 is used in particular to attach the support section 3 to the arm 4, in particular the upper arm, of the user. In particular, the arm shell surrounds the upper arm of the user, in particular at least partially, so that the upper arm can be held in the arm shell with a strap. The user's forearm is expediently not attached to the exoskeleton 20.

The body part is preferably a limb of the human body. For example, the body part is an arm of the human body. Furthermore, the body part may be the back of the human body. In this case, the base section expediently serves for attachment to a leg and/or the pelvis of the human body; i.e. the body section (to which the base section is to be attached) may be, for example, a leg in the case where the body part is the back.

As an example, the support section 3 is mounted so that it can pivot about a horizontal pivot axis relative to the base section 1, in particular relative to the back part 8. As an example, the support section 3 is mounted directly on a shoulder part 29. The horizontal pivot axis can also be referred to as the lifting axis 36. When the exoskeleton 20 is worn, the lifting axis 36 is located in the area of the user's shoulder. In particular, the exoskeleton 20 is designed to support the user's shoulder joint with the support section 3. When the exoskeleton 20 is worn, the user can perform a lifting movement with his arm 4 supported by the support section 3 by pivoting the support section 3 about the lifting axis 36. In particular, the lifting axis 36 can be aligned in the y-direction. Expediently, the lifting axis 36 always lies in a horizontal plane, for example an x-y plane. In particular, a horizontal plane is to be understood as an exactly horizontal plane and/or a plane that is tilted by a maximum of 10 degrees, 7 degrees or 5 degrees relative to a horizon.

The swivel angle 47 of the support section 3 about the lifting axis 36 relative to the base section 1 should also be referred to as the lifting angle. The swivel angle 47 has a reference value, in particular a minimum value, when the support section 3 is oriented downwards (in the case of a vertically oriented exoskeleton 20) and increases continuously up to a maximum value when the support section 3 is pivoted upwards. The minimum value is in particular a minimum value in terms of amount, for example zero.

As an example, the pivot angle 47 is defined as an angle between a support section axis 61 and a base section axis 62. The support section axis 61 extends in the longitudinal direction of the support section 3. Exemplarily, the support section axis 61 extends from the lifting axis 36 in the direction of the arm attachment 12. In a state in which the user has put on the exoskeleton 20, the support section axis 61 expediently extends parallel to an upper arm axis of the arm 4 supported by the support section 3. The base section axis 62 expediently represents a vertical axis of the base section 1 and extends vertically downwards, in particular in a vertical orientation of the base section 1, for example in a state in which the user has put on the exoskeleton 20 and is standing upright. As an example, the pivot angle 47 lies in a z-x plane, for example when the user is standing upright and the arms are raised forwards.

The exoskeleton 20 comprises, by way of example, a shoulder joint arrangement 9, via which the support section 3 is attached to the base section 1, in particular the back part 8. The shoulder joint arrangement 9 expediently comprises a joint chain with one or more pivot bearings for defining one or more vertical axes of rotation. By means of the joint chain, it is expediently possible to pivot the support section 3 relative to the base section 1, in particular relative to the back part 8, in a preferably horizontal pivot plane, for example about a virtual vertical axis of rotation. In particular, the joint chain enables the user to pivot his arm 4, which is supported by the support section 3, about a vertical axis of rotation running through the user's shoulder, whereby the support section 3 is moved along with the arm 4. As an example, the joint chain is designed to be passive, so that the exoskeleton 20 does not provide any active support force in the direction of the horizontal pivot movement when the arm is pivoted in the preferably horizontal pivot plane.

The shoulder joint arrangement 9 is expediently arranged and/or designed in such a way that it defines a free space which, when the exoskeleton 20 is worn, is located above the shoulder of the user wearing the exoskeleton 20, so that the user can align his arm, which is supported by the support section 3, vertically upwards through the free space past the shoulder joint arrangement 9.

By way of example, the shoulder joint arrangement 9 comprises an inner shoulder joint section 27, which is mounted so as to be pivotable about a first vertical axis of rotation relative to the base section 1, in particular to the back part 8, by means of a first pivot bearing of the shoulder joint arrangement 9. By way of example, the shoulder joint arrangement 9 further comprises an outer shoulder joint section 28, which is mounted so as to be pivotable about a second vertical axis of rotation relative to the inner shoulder joint section 27 by means of a second pivot bearing of the shoulder joint arrangement 9. By way of example, the shoulder joint arrangement 9 further comprises a shoulder part 29 which is mounted so as to be pivotable about a third vertical axis of rotation relative to the outer shoulder joint section 28 by means of a third pivot bearing of the shoulder joint arrangement 9. Preferably, the inner shoulder joint section 27, the outer shoulder joint section 28 and the shoulder part 29 in the shoulder joint arrangement 9 are kinematically coupled to one another as the joint chain in such a way that the pivot angle of the inner shoulder joint section 27 relative to the base section 1 determines the pivot angle of the outer shoulder joint section 28 relative to the inner shoulder joint section 27 and/or the pivot angle of the shoulder part 29 relative to the outer shoulder joint section 28.

FIG. 3 shows a schematic detailed view of the support section 3, with components arranged within the arm part visibly shown. The arm part 11 expediently comprises an arm part housing, which is in particular rigid and made of plastic, for example.

The exoskeleton 20 comprises an actuator device 5 acting on the support section 3 to provide a support force for the body part, preferably the limb, exemplarily for the user's arm. By way of example, the actuator device 5 is arranged at least partially in the arm part 11.

The actuator device 5 is an active actuator device. Expediently, the exoskeleton 20 provides the support force by means of the actuator device 5 with a force component acting upwards in the direction of the pivoting movement about the lifting axis 36, which pushes the user's arm 4 upwards in the direction of the pivoting movement.

Preferably, the actuator device 5 comprises an actuator unit with an actuator member 32. The actuator unit can apply an actuator force to the actuator member 32 in order to provide the support force. The actuator member 32 is coupled to an eccentric section 35 arranged eccentrically to the lifting axis 36. The eccentric section 35 is part of the shoulder part 29, for example. By coupling the actuator member 32 to the eccentric section 35, the actuator force provides a torque of the support section 3 about the lifting axis 36 relative to the base section 1 and/or the shoulder part 29. Due to this torque, the support section 3 presses against the body part, preferably the limb, in particular the arm 4, of the user, in particular upwards, and thus provides the support force acting on the body part, preferably the limb, in particular the arm 4, of the user.

As an example, the actuator device 5 has a coupling element 33, in particular designed as a push rod, via which the actuator member 32 is coupled to the eccentric section 35.

Preferably, the actuator device 5 is a pneumatic actuator device and the actuator unit is expediently designed as a pneumatic drive cylinder 31. The actuator member 32 is the piston rod of the drive cylinder 31.

Alternatively, the actuator device may not be designed as a pneumatic actuator device. For example, the actuator device can be designed as a hydraulic and/or electric actuator device and, expediently, comprise a hydraulic drive unit and/or an electric drive unit as the actuator unit.

The drive cylinder 31, the actuator member 32 and/or the coupling element 33 are preferably arranged in the arm part housing.

The exoskeleton 20 expediently comprises a lifting pivot bearing 34, which provides the lifting axis 36. As an example, the support section 3 is attached to the shoulder joint arrangement 9 via the lifting pivot bearing 34.

FIG. 4 shows a rear view of the exoskeleton 20, whereby the textile carrying system and the force transmission element 18 are not shown.

The exoskeleton 20 comprises, by way of example, one or more batteries 22, a compressor 23, a valve unit 24 and/or a compressed air tank 25, which are expediently part of the base section 1 and are arranged in particular in the back part housing.

By way of example, the rechargeable battery 22 is arranged at the bottom of the back part 8 and, in particular, is inserted into a rechargeable battery holder of the back part 8 from below. Expediently, the compressed air tank 25 is arranged in an upper region in the back part 8, exemplarily (in particular in the longitudinal direction of the back part 8 and/or vertical direction) above the valve unit 24, the control device 7, the compressor 23 and/or the rechargeable battery 22. The valve unit 24 and/or the control device 7 is (in particular in the longitudinal direction of the back part 8 and/or vertical direction) expediently arranged above the compressor and/or above the rechargeable battery 22. The compressor 23 is arranged (in particular in the longitudinal direction of the back part 8 and/or vertical direction) above the battery 22.

The battery 22 serves as an electrical power supply for the exoskeleton 20, in particular for the compressor 23, the valve unit 24, a sensor device 6 and/or a control device 7.

The compressor 23 is designed to compress air in order to generate compressed air. The compressed air tank 25 is designed to store compressed air-in particular the compressed air generated by the compressor 23.

The valve unit 24 expediently comprises one or more electrically operable valves and is designed in particular to influence a pneumatic connection from the compressed air tank 25 to a pressure chamber of the pneumatic drive cylinder 31, in particular to selectively establish and/or block the pneumatic connection. Expediently, the valve unit 24 is further designed to influence a pneumatic connection from the compressed air tank 25 to the environment of the exoskeleton 20 and/or a pneumatic connection from the pressure chamber of the drive cylinder 31 to the environment of the exoskeleton 20, in particular to selectively establish and/or block the pneumatic connection. The valve unit 24 is expediently part of the actuator device 5.

The exoskeleton 20 further comprises a sensor device 6. As an example, the sensor device 6 comprises an angle sensor 37 for detecting the angle of the support section 3 relative to the base section 1, in particular the arm part 11 relative to the shoulder part 29. This angle should also be referred to as the pivot angle 47 or the lifting angle. The angle sensor 37 is used in particular to detect the angle of the support section 3 about the lifting axis 36. The angle sensor 37 is designed, for example, as an incremental encoder and is arranged in particular on the lifting pivot bearing 34, in particular in the arm part 11 and/or in the shoulder part 29.

Preferably, the sensor device 6 further comprises at least one pressure sensor for detecting the pressure prevailing in the pressure chamber of the drive cylinder 31 and/or the pressure prevailing in the compressed air tank 25. The at least one pressure sensor is expediently arranged in the back part 8 and/or in the arm part 11.

The exoskeleton device 10, in particular the exoskeleton 20, expediently comprises a control device 7, which for example comprises a microcontroller or is designed as a microcontroller. The control device 7 is used in particular to control the actuator device 5, in particular the valve unit 24, in order to control the provision of the support force. Furthermore, the control device 7 is used to read out the sensor device 6, in particular to read out data recorded by the sensor device 6 and/or to communicate with the tool 30 and/or the mobile device 40. Preferably, the control device 7 is designed to adjust the pressure prevailing in the pressure chamber of the drive cylinder 31 by actuating the valve unit 24, in particular to closed-loop control the pressure, for example taking into account a pressure value recorded by means of the pressure sensor. In particular, the control device 7 is designed to increase the pressure prevailing in the pressure chamber by actuating the valve unit 24 in order to increase the support force and/or to reduce the pressure prevailing in the pressure chamber by actuating the valve unit 24 in order to reduce the support force.

According to a preferred embodiment, the control device 7 is designed to adjust the support force on the basis of the pivot angle 47 of the support section 3 detected in particular by means of the angle sensor 37. Expediently, the user can use his muscle strength to change the pivot angle 47 of the support section 3 by pivoting his arm 4, thereby influencing in particular the provision of the support force. In particular, the support force is low enough so that the user can change the swivel angle 47 of the support section 3 by pivoting his arm 4 using his muscle strength. The support force is limited, for example, by the design of the pneumatic system, in particular the compressor, and/or by the control device 7.

The control device 7 is preferably part of the exoskeleton 20 and is exemplarily arranged in the base section 1, in particular in the back part 8. Optionally, the control device 7 can be at least partially implemented in the mobile device 40.

As an example, the exoskeleton 20 comprises an operating element 14, which is expediently attached to the base section 1 via an operating element cable 15. The user can control the exoskeleton 20 via the operating element 14 and, in particular, activate, deactivate and/or set the support force to one of several possible force values greater than zero.

As an example, the exoskeleton 20 further has a connecting element 26, via which the shoulder joint arrangement 9 is attached to the base section 1, in particular the back part 8. The connecting element 26 is exemplarily designed as a pull-out element. The connecting element 26 is expediently adjustable in its position relative to the base section 1, in particular relative to the back part 8, in order to be able to adapt the position of the shoulder joint arrangement 9 and the support section 3 to the shoulder width of the user. In particular, the position of the connecting element 26 can be adjusted by pushing or pulling the connecting element 26 in or out of the back part 8.

By way of example, the exoskeleton 20 has a first support section 3A, a first shoulder joint arrangement 9A and a first connecting element 26A, as well as a second support section 3B, a second shoulder joint arrangement 9B and a second connecting element 26B. The components whose reference signs are provided with the suffix “A” or “B” are expediently each designed in correspondence with the components provided with the same reference sign number but without the suffix “A” or “B”, for example identical or mirror-symmetrical, so that the explanations in this regard apply in correspondence.

The first support section 3A, the first shoulder joint arrangement 9A and the first connecting element 26A are arranged on a first, exemplarily the right, side (in width direction) of the base section 1, and serve to support a first, in particular the right, arm of the user.

The second support section 3B, the second shoulder joint arrangement 9B and the second connecting element 26B are arranged on a second, exemplarily the left, side (in width direction) of the base section 1 and serve to support a second, in particular the left, arm of the user.

The first support section 3A comprises a first arm part 11A, a first arm attachment 12A and/or a first actuator unit, in particular a first drive cylinder.

The second support section 3A comprises a second arm part 11B, a second arm attachment 12B and/or a second actuator unit, in particular a second drive cylinder.

Preferably, the control device 7 is designed to set a first support force for the first support section 3A by means of the first actuator unit and to set a second support force for the second support section 3B by means of the second actuator unit, which second support force is expediently different from the first support force.

The first shoulder joint arrangement 9A comprises a first inner shoulder joint section 27A, a first outer shoulder joint section 28A and a first shoulder part 29A. The second shoulder joint arrangement 9B comprises a second inner shoulder joint section 27B, a second outer shoulder joint section 28B and a second shoulder part 29B.

The first support section 3A is pivotable about a first horizontal lifting axis 36A relative to the base section 1 and the second support section 3B is pivotable about a second horizontal lifting axis 36B relative to the base section 1.

In FIG. 2, the exoskeleton 20 is shown in a state in which it is worn by a user, in particular worn as intended. By the formulation that the user is wearing the exoskeleton 20, in particular wearing it as intended, it is meant that the user has put on the exoskeleton, i.e. put it on, by way of example in that the user is wearing the back part 8 on his back like a backpack, has put on the pelvic strap 16 around his hips, the shoulder strap or shoulder straps 19 run over the shoulder or shoulders of the user and/or one or both arms of the user are attached to the respective support section 3 with a respective arm attachment 12.

By way of example, the exoskeleton 20 is designed to support the user during a lifting movement of a respective arm, i.e. during an upwardly directed pivoting of the respective support section 3 about a respective lifting axis 36, with a respective support force acting in particular upwards. Furthermore, the exoskeleton 20 is expediently designed to support or counteract the user during a lowering movement, i.e. during a downward pivoting of the respective support section 3 about a respective lifting axis 36, with a respective support force acting in particular upwards, or to deactivate or reduce the respective support force during the lowering movement.

The base section 1 has the main section and the textile carrying system, with which the base section 1 can be attached to the body section, in particular the torso 2. The main section comprises, by way of example, the back part 8 and the force transmission element 18. The textile carrying system comprises, by way of example, a back textile section 401, which comprises, in particular, the back mesh 21, a pelvic strap section, which comprises, in particular, the pelvic strap 16, and a shoulder strap section, which comprises, in particular, the one or the two shoulder straps 19.

The exoskeleton 20 further comprises a carrying system attachment interface with which the textile carrying system is detachably attached to the main section.

The textile carrying system is preferably designed in such a way that, when worn, movement of the back part 8 relative to the user's back is avoided or minimized.

First, the textile carrying system will be discussed in more detail.

In an exemplary embodiment, all components of the textile carrying system are connected and/or interconnected, in particular in a state in which the textile carrying system is detached from the main section. Exemplarily, the shoulder strap section is connected to the back textile section 401, in particular directly, and/or the shoulder strap section is connected to the pelvic strap section, in particular directly. In an exemplary embodiment, there is no direct connection between the pelvic strap section and the back textile section 401 and/or the pelvic strap section and the back textile section 401 are connected indirectly via the shoulder strap section, in particular exclusively via the shoulder strap section, in particular in a state detached from the main section.

An exemplary embodiment of the back textile section 401 can be seen in FIGS. 5, 9 and 10. The back textile section 401 expediently comprises the back mesh 21, a padding section 415, one or two loops 414 and/or one or more fastening tabs 408.

By way of example, the back textile section 401 has a flat shape and is expediently oriented with its largest side in terms of area parallel to the y-direction. The normal vector of the largest surface side of the back textile section 401 is expediently oriented upwards and backwards, i.e. in particular in the (positive) z-direction and (negative) x-direction, and in particular has a y-component of zero. The back textile section 401 is thus oriented with its surface plane angled with respect to an x-y plane.

The back textile section 401 extends from an upper attachment point 404, at which the back textile section 401 is attached to the back part 8, to a lower attachment point 405, at which the back textile section 401 is attached to the back part 8. The direction from the upper attachment point 404 to the lower attachment point 405 is expediently the same as the longitudinal direction of the back textile section 401, in particular in an x-z view. The longitudinal direction of the back textile section 401 extends downwards and backwards, i.e. in particular in the (negative) z-direction and (negative) x-direction, and in particular has a y-component of zero.

The length and the width of the back textile section 401 are expediently a multiple of the thickness of the back textile section 401. The length is the extension along the longitudinal direction, the width is the extension along the y-direction and the thickness is the extension along the normal vector of the largest side of the back textile section 401 in terms of area.

The back mesh 21 has an upper back mesh edge, a lower back mesh edge and two lateral back mesh edges. In particular, the largest side of the back mesh 21 in terms of area can be quadrangular. As an example, the back mesh 21 tapers downwards in its y-extension. In particular, the two lateral edges of the back mesh converge towards the bottom. In the x-z view, the back mesh 21 expediently has the shape of a straight line that runs in the longitudinal direction of the back textile section 401.

In the upper region of the back textile section 401, in particular at the upper back mesh edge, the fastening tabs 408 are arranged, in particular distributed and/or spaced in the y-direction. For example, a left fastening tab 408 is arranged at a left upper corner of the back mesh 21 and/or a right fastening tab 408 is arranged at a right upper corner of the back mesh 21.

In the lower region of the back textile section 401, in particular at the lower back mesh edge, the loops 414 are arranged, in particular distributed and/or spaced in the y-direction. For example, a left loop 414 is arranged at a left lower corner of the back mesh 21 and/or a right loop 414 is arranged at a right lower corner of the back mesh 21.

As an example, the padding section 415 is arranged on the side of the back textile section 401, in particular the back mesh 21, which side is facing away from the back part 8. As an example, the padding section 415 extends only over a partial region of the longitudinal extent of the back textile section 401, in particular of the back mesh 21. For example, the padding section 415 is not present in a lower region 403 of the back textile section 401, in particular of the back mesh 21. In particular, the padding section 415 is not present in the lower quarter of the back mesh 21 (in the longitudinal direction of the back textile section 401).

Preferably, the padding section 415 is designed to allow ventilation behind the user's back. For example, the padding section 415 is designed as a grooved padding and/or is made of a breathable material.

Optionally, the padding section 415 is designed to provide thermal insulation for the user's back, for example for use in winter. In this case, the padding section 415 is preferably made of a thermally insulating material and in particular is not designed as a grooved padding.

As an example, between 30% and 60% of the front side of the back mesh 21 facing away from the back part 8 is covered with the padding section 415.

Optionally, an arrangement comprising the exoskeleton 20 and a replacement padding section is provided. The padding section 415 can be replaced by the replacement padding section. The padding section 415 and the replacement padding section preferably differ in their geometry, size, material and/or thermal insulation.

Optionally, the back mesh 21 is reinforced at the outer edges-in particular at the lateral back mesh edges, at the upper back mesh edge and/or at the lower back mesh edge—by a circumferential band, in particular to achieve, in an x-z view, a curved fit of the back mesh 21, in particular adapted to the human back.

Optionally, the back mesh 21 is stiffened, for example by insertion of elastic profiles such as fiberglass rods.

Expediently, the back mesh 21 is stretched in a planar manner by the arrangement of the fastening tabs 408 and the loops 414 and preferably in this way is given the already described course relative to the back part 8. Alternatively or additionally, the stretched state of the back mesh 21 can be realized by the reinforcement and/or stiffening described.

By way of example, the back mesh 21 has an extension of 20 cm to 30 cm, preferably an extension of 25 cm, from the upper back mesh edge to the lower back mesh edge. By way of example, the width, i.e. the extension in the y-direction, of the back mesh 21 is between 10 cm and 25 cm, for example 15 cm, in the area of the upper back mesh edge and between 4 cm and 25 cm, for example 8 cm, in the area of the lower back mesh edge.

The pelvic strap section comprises, by way of example, the pelvic strap 16 and a second joint section 306 (which in particular forms part of the force transmission element joint 17). The pelvic strap 16 comprises a front strap section 416 and a rear strap section 417.

The front strap section 416 exemplarily has a smaller z-extension than the rear strap section 417 and/or is made of a different material, in particular a more flexible material, than the rear strap section 417. By way of example, the rear strap section 417 has the shape of a ring section, in particular a half ring. The front strap section 416 is attached to the front ends of the rear strap section 417. The pelvic strap 16 has the shape of a loop and has a fastener 418, in particular on the front strap section 416, with which the pelvic strap 16 can be opened and closed.

The shoulder strap section comprises the one or two shoulder straps 19. The shoulder strap section, in particular each strap 19, extends from the upper region 402 of the back textile section 401, in particular from the upper back textile edge, to the pelvic strap section, in particular to the pelvic strap 16, preferably to the rear strap section 417. As an example, a left shoulder strap 19 extends from a left upper corner of the back mesh 21 to an area to the left of the center (in the width direction) of the rear strap section 417 and/or a right shoulder strap 19 extends from a right upper corner of the back mesh 21 to an area to the right of the center (in the width direction) of the rear strap section 417.

Preferably, the back textile section 401 is stretched between the upper attachment point 404 on the back part 8 and the lower attachment point 405 on the back part 8 arranged below the upper attachment point 404, so that the back textile section 401 is spaced from the back part 8 between the upper attachment point 404 and the lower attachment point 405. In particular, the back textile section 401 is arranged on the main section in such a way that the back textile section 401 enables ventilation, in particular rear ventilation, of the user's back, in particular by using an air-permeable and/or breathable back textile section 401.

By way of example, the (in particular rigid) back part 8, in particular the back part housing, is curved on the front side (i.e. the side to which the back textile section 401 is attached) in such a way that, in an x-z view, a concave course is produced in relation to the user and/or in the x-direction towards the front. In an x-z view, the back textile section 401 is expediently less curved than the front side of the back part 8 and/or has a straight course, so that the front side of the back part 8, starting from the upper attachment point 404 in the direction towards the lower attachment point 405, moves further and further away from the back textile section 401 in the x-z view, until a maximum distance of in particular more than three centimeters is reached between the front side and the back textile section 401, and then moves closer and closer to the back textile section 401 up to the lower attachment point 405.

The back part 8 is designed in particular as a hard component, preferably as a rigid component, and the back textile section 401 is expediently designed as a flexible component, in particular as a non-rigid component. In particular, the distance between the back part 8 and the back textile section 401 makes it possible to adapt the shape of the back textile section 401 to the shape of the user's back.

As an example, the back part 8 has an extension in the z-direction of 40 cm to 60 cm, for example an extension of 50 cm. The largest extension in the y-direction is between 10 cm and 25 cm, for example 19 cm. The thickness of the back part is, for example, 10 cm, in particular at at least one point.

Preferably, the back textile section 401 lies flat against the user's back when the exoskeleton 20 is put on, in particular at least partially, and its shape adapts to the shape of the user's back. The back part 8 expediently does not lie against the user's back or does not lie flat against the user's back and/or does not adapt its shape to the user's back.

By way of example, the back textile section 401 has loops 414 with which the back textile section 401 is hooked into hooks 410 arranged on the back part 8 at the lower attachment point 405. Expediently, the lower attachment point 405 is located between the center (in the z-direction) and the lower end of the back part 8, preferably above the lower quarter of the z-extension of the back part 8.

By way of example, the back textile section 401 has fastening tabs 408, with which the back textile section 401 is detachably fastened to the upper attachment point 404 by means of fastening bolts 409 arranged on the back part 8. Expediently, the upper attachment point 404 is arranged at the level of the shoulder joint arrangement 9.

The back textile section 401 is designed in particular as a back mesh section and is expediently used for contact, in particular at least partial contact, with the back of a user of the exoskeleton 20.

Preferably, the back textile section 401 is formed by the attachment to the main section, in particular the back part 8, into a shape in which, in a state in which the exoskeleton 20 is attached to a user and the user assumes an upright posture, the back textile section 401 with an upper region 402 of the back textile section 401 abuts against an upper back region of the user and, starting from the upper region 402, projecting diagonally downwards away from the user's back, so that a lower region 403 of the back textile section 401 is spaced from the user's back. For example, the back textile section 401 is spaced from the user's back with at least the lower quarter of its z-extension.

The lower region 403 extends, by way of example, over at least 30% and/or at most 60% of the longitudinal extent of the back textile section 401.

In particular, due to the attachment to the back part 8, the back textile section 401 has a shape extending downwards (i.e. in the negative z-direction) and rearwards (i.e. in the negative x-direction) starting from the upper attachment point 404 in the x-z view. In particular, the back textile section 401 extends diagonally downwards and rearwards over its entire longitudinal extent in the x-z view, starting from the upper attachment point 404. Preferably, in the x-z view, the angle between the course of the back textile section 401 and the z-direction is between 10 and 30 degrees, exemplarily 20 degrees.

FIG. 2 shows the partial contact of the back textile section 401 with the human body. Due to the curved shape of the back part and due to the back textile section 401 extending diagonally downwards and backwards (in the x-z view), when the user is standing upright, only the upper region 402, in particular the padded section 415, of the back textile section 401 rests against the user, for example against or between the user's shoulder blades.

Preferably, by being attached to the main section, in particular to the back part 8, the back textile section 401 is displaced into a shape in which the upper region 402 and the lower region 403 of the back textile section 401 rest against the user's back in a state in which the exoskeleton 20 is attached to the user and the user assumes a forwardly bent body posture.

As shown in FIG. 11, the curved shape of the back part 8 allows the user to bend forward and/or downward with the exoskeleton 20 in place. In this state, a larger proportion of the back textile section 401 is in contact with the user's back.

The carrying system attachment interface is described in more detail below.

In particular, the carrying system attachment interface enables tool-free removal of the textile carrying system from the main section and, expediently, subsequent tool-free attachment of the previously removed textile carrying system or another textile carrying system to the main section. In particular, the carrying system attachment interface enables complete removal of the textile carrying system from the main section, so that the textile carrying system is completely separated from the main section, in particular from the exoskeleton 20.

The carrying system attachment interface is preferably designed as a quick-change system. By means of the carrying system attachment interface, the textile carrying system, in particular the textile components, can be removed from the exoskeleton 20, for example in order to then wash it in the removed state, for example in an industrial or craft environment integrated into an existing cleaning process for work clothing.

The hardware of the exoskeleton 20 without the textile components, in particular without the textile carrying system, shall also be referred to as the exoskeleton main part. The exoskeleton main part comprises the main section, each shoulder joint arrangement 9 and each support section 3. By separating the textile carrying system, in particular the textile components, from the exoskeleton main part, in particular from the main section, it becomes possible for several users to access the same exoskeleton main part one after the other, whereby each user can use a personalized textile carrying system, for example his own textile carrying system, and/or a freshly washed textile carrying system together with the exoskeleton main part.

By way of example, the textile carrying system comprises the back textile section 401, the shoulder strap section and the pelvic strap section.

Expediently, the back textile section 401, the shoulder strap section and the pelvic strap section form a unit—the textile carrying system—which can be detached and removed from the exoskeleton main part with a few manual operations of the carrying system attachment interface, for example less than ten manual operations.

The carrying system attachment interface expediently comprises at least two fastening devices that are arranged in a distributed manner and/or can be released independently of one another, exemplarily a safety fastening device 406, an additional fastening device and a joint fastening device. In particular, several or all of the fastening devices must be released in order to be able to remove the textile carrying system from the exoskeleton main part.

By way of example, the textile carrying system is fastened to the main section, in particular to the back part 8 and/or to the force transmission element 18, at various attachment points via the carrying system attachment interface. By way of example, the back textile section 401 is attached to the back part 8 at the upper attachment point 404 via the safety fastening device 406 and is attached to the back part 8 at the lower attachment point 405 via the additional fastening device. As an example, the pelvic strap section is fastened to the force transmission element 18 via the joint fastening device at a joint attachment point arranged below the lower attachment point 405.

In the textile carrying system, the attachment points for attachment to the main section are expediently located on an upper edge and/or lower edge of the back textile section 401, in particular the back mesh 21, and/or a rear side of the pelvic strap section, in particular the pelvic strap 16.

The safety fastening device 406 will be discussed in more detail below.

The textile carrying system, in particular the back textile section 401, is fastened to the main section, in particular to the back part 8, via the safety fastening device 406. To release the safety fastening device 406, at least two successive, different release actuations of the safety fastening device 406 are required.

An exemplary embodiment of the safety fastening device 406 can be seen in FIGS. 6 and 7.

By way of example, the safety fastening device 406 has a tab receptacle 407, a fastening tab 408 inserted into the tab receptacle 407 and a fastening bolt 409 inserted into the fastening tab 408. The tab receptacle 407 and the fastening bolt 409 are expediently arranged on the back part 8. To release the safety fastening device 406, the first release operation required is to pull the fastening bolt 409 out of the fastening tab 408. As a second release operation, expediently a pulling of the fastening tab 408 out of the tab receptacle 407 is required.

The tab receptacle 407 has a receiving space for receiving the fastening tab 408. The receiving space is expediently oriented such that the fastening tab 408 does not move out of the tab receptacle 407 by itself, for example due to the weight of the back part 8 and/or the fastening tab 408, when the exoskeleton is worn by the user and when the fastening bolt 409 is pulled out of the fastening tab 408. For example, the tab receptacle 407 is oriented with its receiving space to the rear and/or upwards, so that the fastening tab 408 must be pulled forwards and/or downwards in a release direction (relative to the back part 8) in order to move the fastening tab 408 out of the tab receptacle 407. Expediently, the fastening tab 408 is blocked in the release direction when the exoskeleton 20 is worn, for example by the exoskeleton 20 and/or by the user.

By way of example, the safety fastening device 406 has two safety fastening units, each safety fastening unit having a respective tab receptacle 407, a respective fastening tab 408 and/or a respective fastening bolt 409, which are expediently designed as explained above and/or below and/or interact with one another as explained above and/or below. One of the safety fastening units is arranged in the upper right region of the back part 8 and the other safety fastening unit is arranged in the upper left region of the back part. The safety fastening device 406, in particular the two safety fastening units, are expediently arranged at the upper attachment point 404, in particular at the level of the shoulder joint arrangement 9.

Expediently, each safety fastening unit 406 is positioned on the back part 8 such that each fastening tab 408 is located approximately at the level of the user's cervical vertebra C7 when the exoskeleton 20 is worn. In this way, it can be ensured that the shoulder straps 19 have sufficient lateral play to be worn by users with both broad and narrow shoulders.

To release the safety fastening device 406, two different release actuations—for example the above explained first release actuation and the second release actuation—are expediently required per safety fastening unit.

FIG. 7 shows an exemplary embodiment of such, in particular each, safety fastening unit 406. The fastening tab 408 is exemplarily fastened to the back textile section 401 via a connecting section 421, for example a connecting textile. The fastening tab 408 comprises a bolt opening 419, into which the fastening bolt 409 can be inserted for locking the fastening tab 408 in the tab receptacle 407. The tab receptacle 407 has a receiving slot 420 into which the fastening tab 408 can be inserted. The safety fastening unit 406 arranged on the back part 8 expediently comprises a spring, with which the fastening bolt 409 is pretensioned so that it remains inserted in the bolt opening 419 without the first release actuation. The fastening tabs 408 are preferably made of plastic. Preferably, the fastening bolt 409 engages through the fastening tab 408 and is held in particular on both sides of the fastening tab 408 in the tab receptacle 407. Expediently, a respective pulling element 422, for example a pulling ring and/or a pulling tab, is attached to each fastening bolt 409, which the user can grip in order to pull the fastening bolt 409 out of the bolt opening 419.

The textile carrying system is connected to the back part 8 on the upper side of the back mesh 21 by means of the fastening tabs 408. For this purpose, each fastening tab 408 is inserted into a respective receiving slot 420 and secured from above with a respective fastening bolt 409, which extends through the fastening tab 408 inserted into the receiving slot 420. To release the respective fastening tab 408, the fastening bolt 409 is pulled (against a spring bias which holds the fastening bolt 409 in the locked position) on a pulling element 422 out of the bolt opening 419 to such an extent that the fastening tab 408 can be pulled out of the receiving slot 420.

Expediently, a closing actuation is required to close the safety fastening device 406, in which the fastening tab 408 is pushed into the tab receptacle 407 and the fastening bolt 409 thereby automatically moves into the fastening tab 408.

Preferably, each safety fastening unit 406 can be closed with only one hand, since the fastening bolt 409 is spring-biased, and the shape of the fastening tab 408 initially displaces the fastening bolt 409 against the spring bias when the fastening tab 408 is inserted into the receiving slot 420, the displacement occurring in particular in the direction perpendicular to the direction of insertion, until the bolt opening 419 is positioned on the fastening bolt 409, so that the fastening bolt 409 snaps into the bolt opening 419 due to the spring bias.

Preferably, the carrying system attachment interface comprises the additional fastening device with at least one hook 410 and/or a lever fastener. The additional fastening device, in particular the at least one hook 410 and/or lever fastener, is expediently arranged at the lower attachment point 405.

An exemplary embodiment of the additional fastening device is shown in FIG. 8. As an example, the additional fastening device comprises two hooks 410, which are arranged on the back part 8, in particular distributed and/or spaced apart in the width direction. By way of example, the hooks 410 are oriented vertically downwards. The back textile section 401 is hooked into the hooks 410 with its loops 414.

Optionally, the additional fastening device can have one or more lever fasteners. Each lever fastener expediently has a lever element that can be actuated by the user, via the actuation of which the back textile section, in particular the back mesh, can be tensioned, in particular in the longitudinal direction. Each lever fastener expediently has a dead center for the respective lever element, so that the lever element is held in its position after the dead center is exceeded.

Optionally, the additional fastening device can have an eyelet or a hole.

The carrying system attachment interface expediently further comprises the joint fastening device, which has a first joint section 305 belonging to the textile carrying system and a second joint section 306 belonging to the main section, wherein the first joint section 305 and the second joint section 306 form a joint, in particular the force transmission element joint 17, between the textile carrying system, in particular the pelvic strap section, and the main section, in particular the force transmission element 18, and the first joint section 305 is detachable from the second joint section 306, in order to release the joint fastening device. By way of example, the joint fastening device has an actuating element 313, in particular an actuating lever, and the first joint section 305 can be detached from the second joint section 306 by actuating the actuating element 313.

The force transmission element joint 17 connects the force transmission element 18, which is in particular strip-shaped, to the pelvic strap section and expediently provides one or more translational and/or rotational degrees of freedom between the force transmission element 18 and the pelvic strap section. Preferably, the force transmission element joint 17 is designed as a ball joint and/or provides three rotational degrees of freedom between the force transmission element 18 and the pelvic strap section. The force transmission element joint 17 is expediently the only joint on the pelvic strap section and/or the only joint connection to the pelvic strap section and/or the only joint connection between the pelvic strap section and the force transmission element 18.

The one degree of freedom or the multiple degrees of freedom are provided in particular between the first joint section 305 and the second joint section 306. For example, the first joint section 305 is a part, in particular a lower part, of the force transmission element 18.

In an exemplary embodiment, the second joint section 306 is attached to the pelvic strap 16, as shown, for example, in FIG. 10. Exemplarily, the second joint section 306 comprises an outer fastening section 307, which is in particular designed as an outer fastening plate, as shown, for example, in FIG. 13. Expediently, the second joint section 306 further comprises at least one inner fastening section 308, which comprises, for example, at least one inner fastening plate.

The outer fastening section 307 and the inner fastening section 308 expediently serve to introduce a force transmitted by the force transmission element 18 into the pelvic strap 16. Expediently, the outer fastening section 307 and/or the inner fastening section 308 extend in the z-direction over at least half of the z-extension of the pelvic strap 16. As an example, the y-extension of the outer fastening section 307 and/or the inner fastening section 308 is between 15 and 20 cm.

For better visualization, the pelvic strap 16 is not shown in FIG. 13.

Preferably, the outer fastening section 307 is on the outside-i.e. in particular on the side facing away from the user—of the pelvic strap 16, and the inner fastening section 308 is preferably on the inside—i.e. in particular on the side facing the user—of the pelvic strap 16. The outer fastening section 307 and the inner fastening section 308 are expediently fastened to one another, in particular by one or more screws which extend, for example, through the pelvic strap 16.

The force transmission element joint 17 is designed in particular as a ball joint.

Preferably, the force transmission element joint 17 comprises a ball section 309, which is exemplarily part of the second joint section 306 and in particular is attached to the outer fastening section 307. The ball section 309 is shown in FIG. 14. For example, the ball section 309 protrudes rearwardly from the preferably plate-shaped outer fastening section 307, exemplarily in the (in particular negative) x-direction. The ball section 309 has a ball head 310.

As an example, the ball head is made of a plastic, for example glass fiber-reinforced polyamide, in particular Schulamid 6 GF30.

The ball head 310 is preferably flattened. In particular, the ball head 310 has the shape of a flattened ball. In particular, the side of the ball head 310 facing away from the pelvic strap 16 is flattened. For example, the ball head 310 has the shape of a sphere, a part of which has been cut off in the vertical plane. The flattened ball head preferably provides a more compact joint arrangement. In particular, the flattened ball head enables a reduction of the lever arm acting on the second joint section 306 as a result of the introduction of force from the first joint section 305.

Expediently, the force transmission element joint 17 further comprises a ball head receptacle 311, which receives the ball head 310, and in particular is part of the first joint section 305.

The ball head receptacle 311 is preferably made of metal. Expediently, the ball head section 309 is removable from the exoskeleton 20, in particular together with the outer fastening section 307, for example by loosening corresponding screws and by unlocking the locking mechanism 312 explained below, and then replaceable, for example when the ball head 310 is worn.

According to an alternative embodiment, the ball section 309 is part of the first joint section 305 and the ball head receptacle 311 is part of the second joint section 306.

The second joint section 306 can be removed from the first joint section 305, in particular tool-free, for example in order to remove the pelvic strap 16 (in particular together with the second joint section 305) from the back part 8 and/or from the rigid force transmission element 18.

Preferably, the exoskeleton 20 comprises a locking mechanism 312 for locking the second joint section 306 to the first joint section 305. By way of example, the locking mechanism 312 has the manually operable actuating element 313, via the actuation of which the locking mechanism can be released. Preferably, the locking mechanism 312 is a purely mechanical locking mechanism.

FIGS. 14 and 15 show an exemplary embodiment of the locking mechanism 312. FIG. 14 shows a section through an x-z plane and FIG. 15 shows a section through a y-z plane. The sections each run through the ball head 310.

Expediently, the locking mechanism 312 serves to selectively lock the ball head 310 in the ball head receptacle 311 so that the ball head 310 cannot be removed from the ball head receptacle 311, or to release the ball head 310 relative to the ball head receptacle 311 so that the ball head 310 can be removed from the ball head receptacle 311. The locking mechanism 312 is preferably operable without the aid of tools.

As an example, the locking mechanism has a locking part 314, which is expediently mechanically connected to the actuating element 313 and, in particular, can be moved via the actuating element 313 in order to move the locking part 314 selectively into a locking position or into a release position. In the locking position, the locking part 314 holds the ball head 310 at least partially in a locking recess 315, whereby the ball head 310 is locked in the ball head receptacle 311. By way of example, the locking recess 315 is arranged above the ball head 310 and/or the locking part 314 is expediently arranged below the ball head 310.

As an example, the locking part 314 can be rotated via the actuating element 313 about an axis of rotation extending in particular parallel to the y-direction in order to move the locking part 314 by rotation either into the locking position or the release position.

The locking part 314 expediently comprises a release recess 316, which in the release position faces the ball head 310, so that the ball head 310 can leave the locking recess 315 by moving into a space released by the release recess 316. In the locked position, the release recess 316 does not face the ball head 310.

The actuating element 313 is preferably designed as an operating lever and, in particular, can be rotated about an axis of rotation running parallel to the y-direction, for example by the user, in order to move the locking part 314 either into the locked position or the release position. For example, a rotation of 90 degrees is required to move the locking part 314 from the locked position to the release position.

By way of example, the actuating element 313 is part of the first joint section 305, in particular part of the force transmission element 18. In particular, the actuating element 313 is arranged on a lateral edge (in the width direction) of the force transmission element 18. In particular, the actuating element 313 is integrated into the force transmission element 18 in such a way that the actuating element 313 continuously continues a lateral outer contour (in the width direction) of the force transmission element 18. The part of the force transmission element 18 without the actuating element 313 shall also be referred to as the force transmission element body 317. The force transmission element 18 comprises the force transmission element body 317 and the actuating element 313. A recess is provided in the force transmission element body, in particular at the lateral edge (in the width direction), in which the actuating element 313 is arranged. The recess is expediently the same size as the actuating element 313 and completely accommodates the actuating element 313. Coming from above along the lateral outer contour of the force transmission element body 317, the recess is formed by a step 318 in the lateral outer contour inwards towards the center (in the width direction) of the force transmission element 18 and a subsequent vertically downwardly extending section 319 of the lateral outer contour of the force transmission element body 317.

Preferably, two different, successive actuating movements of the actuating element 313 are required to release the locking mechanism.

In an exemplary embodiment, the actuating element 313 can optionally be set to a securing state or an actuating state, in particular by the user, and can expediently be set to the release position only in the actuating state, and in particular not in the securing state. In particular, a first actuating movement of the actuating element 313, for example pulling the actuating element 313 laterally outwards in the width direction, is required in order to move the actuating element 313 from the securing state to the actuating state, and then a second actuating movement, in particular a rotation of the actuating element 313 about an axis of rotation extending parallel to the y-direction, is required in order to move the actuating element 313 in the actuating state from the locking position to the release position.

In an exemplary embodiment, the actuating element 313 has a first engagement section 321 which, in the securing state, engages with a second engagement section 322 of the force transmission element body 317 and thereby prevents the actuating element 313 from being moved into the release position. As an example, the first engagement section 321 is designed as a projection, in particular projecting laterally, and the second engagement section 322 is designed as a recess, in particular at the side. By pulling the actuating element 313 laterally outwards in the width direction, the engagement between the first engagement section 321 and the second engagement section 322 is released, so that rotation of the actuating element 313 about an axis of rotation running parallel to the y-direction is made possible.

As explained above, to separate the textile carrying system from the exoskeleton main part, three different fastening devices-the safety fastening device, the additional fastening device and the joint fastening device-must be released. For example, the safety fastening device is first released by pulling each fastening bolt 409 out of the respective bolt opening 419. Subsequently, the additional fastening device is released by pulling each loop 414 from the respective hook 410. Finally, the joint fastening device is released by actuating the actuating element 313 and removing the second joint section 306 from the first joint section 305. The textile carrying system can now be completely removed from the exoskeleton main part.

The textile carrying system is then washed in a washing machine, for example. The textile carrying system is expediently machine washable.

To attach the textile carrying system to the exoskeleton main part, the ball head 310 is first inserted into the ball head receptacle 311 and locked in the ball head receptacle 311 by actuating the actuating element 313. Subsequently, the back textile section 401 is hooked with its loops 414 into the hooks 410 of the back part 8 and then fastened to the back part by means of the fastening tabs 408 and the fastening bolts 409.

Optionally, a fastening via the additional fastening device and the safety fastening device can be performed first, and only then can a fastening via the joint fastening device be performed.

FIG. 12 shows an arrangement 60 comprising the exoskeleton 20, wherein the textile carrying system is a first textile carrying system and the arrangement 60 further comprises a second textile carrying system 412. The first textile carrying system is interchangeable with the second textile carrying system 412. Preferably, the second textile carrying system 412 is constructed like the first textile carrying system and/or is attachable to the main section via the carrying system attachment interface like the first textile carrying system. In particular, the second textile carrying system comprises a back textile section, a shoulder strap section and/or a pelvic strap section.

In particular, the arrangement 60 may be operated by a method in which the first textile carrying system is removed from the main section, in particular by releasing the carrying system attachment interface, and then the second textile carrying system 412 is attached to the main section, in particular by means of the carrying system attachment interface.

Optionally, the second textile carrying system 412 differs from the first textile carrying system, in particular in its size and/or padding and/or material.

Expediently, the textile carrying system has one or more adjustable strap lengths, such as a length of each shoulder strap 19 and/or a length of the pelvic strap 16. Expediently, multiple users may use the exoskeleton main body in succession, each using their own textile carrying system provided with corresponding personalized strap lengths and/or other personalized settings. For example, the first textile carrying system has one or more strap lengths set differently than the second textile carrying system 412.

Preferably, the textile carrying system can have information, in particular user-specific information, which is arranged, for example, as a marking on the outside of the textile carrying system and/or is stored on a chip in the textile carrying system. The information can, for example, include an identification, in particular a name, of the user and/or a department and/or an access authorization. In particular, the information is arranged at a location that is visible from the outside, for example on a shoulder strap. For example, the first textile carrying system comprises a different information than the second textile carrying system.

Optionally, the first textile carrying system and the second textile carrying system 412 are designed for different users and/or contexts of use. For example, the first textile carrying system is designed for use at higher temperatures and/or in summer, and/or the second textile carrying system 412 is designed for use at lower temperatures and/or in winter. For example, the first textile carrying system is designed with a higher thermal insulation than the second textile carrying system. Optionally, the first textile carrying system may have a ventilation unit and/or cooling unit and/or the second textile carrying system 412 may have a heating unit. Preferably, the first and second textile carrying systems can each be adapted to a specific body shape. For example, the first textile carrying system is adapted to a male body shape and/or the second textile carrying system is adapted to a female body shape.

For example, the first textile carrying system is worn out and is replaced by the second carrier system, which is not worn out.

Preferably, the back textile section 401 is attached to the main section in such a way that the length of the main section can be adjusted, in particular adapted to an upper body size of the user, in particular without removing the back textile section 401 from the main section. By way of example, the back textile section 401 is attached to the back part 8, in particular exclusively to the back part 8, and in particular not to the force transmission element 18. The length of the main section can be adjusted, in particular by adjusting the force transmission element 18 relative to the back part 8, and preferably independently of the back textile section 401 (which is only attached to the back part 8).

Optionally, the length of the back textile section can be adapted to an upper body size of the user, in particular by adjusting a distance between the upper attachment point, to which the back textile section is attached to the main section, and a/the lower attachment point, to which the back textile section is attached to the main section, in particular by adjusting the length of the main section. In this case, the upper attachment point is expediently arranged on the back part and the lower attachment point is arranged on the force transmission element. The length of the back textile section can be adjusted by adjusting the force transmission element 18 relative to the back part, which expediently also adjusts the length of the main section.

Optionally, the exoskeleton 20 has a colored guidance system that highlights and clarifies interaction points, in particular the carrying system attachment interface, and/or adjustment options for the user. For example, colored flags are provided as pulling elements 422 of the fastening bolts 409, which on the one hand increase the gripping surface and on the other hand indicate the interaction option to the user by means of an indicator color. Optionally, the loops 414 and/or the actuating element 313 can have the indicator color.

Optionally, poka-yoke mechanisms can be provided to prevent incorrect installation.

As an option, the textile carrying system has a carrying handle on the top that can be used to lift and carry the exoskeleton 20 with one hand.

In the following, with reference to FIGS. 16 to 19, the arm attachments 12 will be discussed in more detail. In FIGS. 16 to 19 and in the following explanations, it is assumed that the support section 3, in particular the support section axis 61, is aligned parallel to the x-direction and that the arm attachment 12 is correspondingly aligned in space.

Preferably, each arm attachment 12 comprises an arm shell 431 designed in particular as a rigid component and a textile arm receptacle 432 arranged in the arm shell 431. Expediently, each arm attachment 12 comprises a closure band 434 with a closure 438 for closing the respective arm attachment 12.

When the exoskeleton 20 is worn, the arm, in particular the upper arm, of the user is at least partially accommodated, in particular at least partially enclosed, by the textile arm receptacle 431. Expediently, forces are transferred from the upper arm into the exoskeleton 20, in particular the support section 3, via the textile arm receptacle 432. In particular, the support force provided by the exoskeleton 20, in particular by the arm part 11, is introduced into the arm, in particular the upper arm, via the textile arm receptacle 432, in particular introduced over a large area.

The textile arm receptacle 432 is attached to two opposite areas of the arm shell 431, so that the textile arm receptacle expediently hangs like a hammock between the two attachment ends of the arm shell 431. As an example, the textile arm receptacle 432 is attached to two opposite upper ends of the arm shell 431 and expediently hangs downwards between the two upper ends, so that the textile arm receptacle has, for example, a U-shape in a y-z section.

The arm shell 431 is designed in particular as a cylindrical half-shell, which can have a U-cross-section in a plane transverse to the arm, in particular in a y-z plane, as shown in FIG. 16. The arm shell 431 is dimensionally stable, in particular rigid, for example in the form of a hard shell.

The arm shell 431 serves as a connection between the textile arm receptacle 431 and the arm part 11. The connection of the arm shell 431 to the arm part 11 can preferably be positioned laterally (with the outside of the arm shell 431 on the exoskeleton 20) or on the upper side of the arm part 11. Preferably, the arm shell 431 is connected to the arm part 11 via an adjustment mechanism with which the user can adjust the position of the arm shell 431 relative to his upper arm, for example to a position that is comfortable for him.

Optionally, the arm shell 431 has a convex upper surface 433 in a plane along the arm, in particular an x-z plane, as shown in FIG. 18. The advantage of this shape is that the arm has more freedom of movement and can move in the arm shell 431 without being pressed or pinched.

The arm shell 431 serves to stretch the textile arm receptacle 432 so that the upper arm does not touch the arm shell 431 or does not touch it over an area, thus ensuring good ventilation of the arm in the area of contact with the textile arm receptacle 432. The user's arm lies in the textile arm receptacle 432 and is fixed above the biceps by an elastic closure band 434.

The textile arm receptacle 432 is exchangeable and can be adapted to the size of the upper arm, whereby the gap between the arm shell 431 and the textile arm receptacle 432 allows movement of the textile receptacle 432 as well as air circulation.

As the material of the textile arm receptacle 432 only absorbs tensile forces due to its design, it can be thin-walled and therefore permeable to perspiration. In conjunction with the air circulation, this prevents the accumulation of sweat, which significantly increases wearing comfort for the user.

The design principle described offers numerous variation parameters for adaptation to the specific application. For example, the hardness of the arm shell 431, the length of the arm receptacle 432, i.e. the size of the contact surface, the choice of an elongated attachment 435 (see FIG. 18) or point attachment (see FIG. 17) of the textile receptacle 432 to the arm shell 431 and the distance between a lower apex of the arm shell 431 and the textile arm receptacle 432 influence the possibility of rotation, air circulation and the targeted application of force.

For example, a point-shaped attachment 436 of the textile arm receptacle 432 to the arm shell 431 is provided, which can, for example, enable a high degree of rotation between these components (analogy to a hammock). The rotation is limited with increasing linear attachment.

Furthermore, an elongate attachment 435 of the textile arm receptacle 432 to the arm shell 431 may be provided.

Furthermore, the stiffness of the system of arm shell 431 and textile arm receptacle 432 influences the damping of the power transmission from the support section 3 to the arm 4.

Optionally, the textile arm receptacle 432 has a convex shape in the longitudinal direction of the arm, i.e. in the x-direction as an example. Preferably, this is implemented by a curved suspension 437 on the arm shell 431. Optionally, this shape can be implemented by “opening up” the textile arm receptacle 432 laterally in the cut construction in order to achieve a curved fit. In this case, at the front edge and/or the rear edge (as seen in the longitudinal direction of the arm) of the textile arm receptacle 432, an additional width is constructed which increases towards the edge and leads to an outward curvature of the textile arm receptacle 432, directed away from the arm. In this way, constriction of the arm at the edges of the textile arm receptacle 432 can be avoided.

Optionally, the textile arm receptacle 432 has the shape of a double-curved surface due to the superposition of the curved cross-sections in the planes transverse and longitudinal to the arm. This shape corresponds, for example, to a section of the outer surface of a hyperboloid. An advantage of this shape is that the arm can roll in the longitudinal direction on the textile arm receptacle 432 and is therefore not constricted or pressed at an edge of the textile arm receptacle 432.

The suspension of the textile arm receptacle 432 on the arm shell 431 allows the user a high range of movement of the arm without causing any hindrance or reduced wearing comfort.

Optionally, the longitudinal extension (in x-direction) of the fastening ends of the arm shell 431 is smaller than the largest longitudinal extension (in x-direction) of the arm receptacle 432, in particular smaller than 75%, smaller than 65%, smaller than 50% of the largest longitudinal extension (in x-direction) of the arm receptacle 432.

By way of example, there is a point-shaped attachment 436 of the textile arm receptacle 432 to the arm shell 431, which in particular enables rotation of the arm relative to the support section 3.

The design of the arm shell 431 with hanging textile arm receptacle 432 enables adaptation to the varying diameter and shape of the upper arm due to the tensing and relaxing of the upper arm muscles. In this way, a functional connection and power transmission between the upper arm and support section 3 is made possible both when the muscles are tensed and relaxed. In particular, there is no friction between the upper arm and the textile arm receptacle 432.

The suspended attachment of the textile arm receptacle 432 replaces padding and enables air circulation underneath the arm, so heat and moisture regulation can be achieved by using appropriate textiles in this way.

The exoskeleton described above shall also be referred to as an exoskeleton according to a first embodiment.

FIGS. 20 and 21 show an exoskeleton 20 according to a second embodiment. In this exoskeleton 20, the base section 1 serves to attach to a leg (or both legs) of the human body and the support section 3 serves to support the back of the human body. Expediently, the exoskeleton 20 according to this second embodiment is designed like the exoskeleton according to the first embodiment explained above (except for the differences explained below), so that the explanations relating to the first embodiment also apply in this respect to the second embodiment explained below.

The exoskeleton 20 comprises the base section 1 for attachment to a body section, namely a leg (or both legs), of the human body. The base section 1 may also be referred to as a leg base section. As an example, the base section 1 is attached to one or both legs of the user.

The exoskeleton 20 further comprises the support section 3 movably coupled to the base section 1 for supporting a body part, namely the back, of the human body. The exoskeleton 20 comprises the actuator device, in particular the pneumatic actuator device, acting on the support section 3 to provide a support force for the body part, namely the back. The support section 3 may also be referred to as the back support section.

The support section 3 comprises the main section and the textile carrying system with which the support section 3 can be attached to the body part, namely the back of the human body. The exoskeleton 20 further comprises a carrying system attachment interface with which the textile carrying system is detachably attached to the main section.

The main section, the textile carrying system and/or the carrying system attachment interface of the second embodiment are expediently designed like the above-mentioned main section, the above-mentioned textile carrying system and the above-mentioned carrying system attachment interface of the first embodiment. The support section 3 of the second embodiment can optionally be designed like the base section explained in connection with the first embodiment (which is used in particular for attachment to the torso 2).

As an example, the support section 3 is pivotably mounted relative to the base section 1 about a horizontal pivot axis 36. By way of example, the horizontal pivot axis 36 (in a state in which the user has put on the exoskeleton 20 as intended) is located at the level of the user's pelvis or hip, in particular the user's hip joint. Preferably, the actuator device is arranged on the pivot axis 36—thus preferably also at the level of the pelvis or the hip of the user (in the worn state of the exoskeleton).

The pivot angle of the support section 3 about the horizontal pivot axis 36 relative to the base section 1 should be referred to as the pivot angle 47. With a vertically aligned support section 3 (with a vertically aligned exoskeleton 20), the pivot angle 47 has a reference value, in particular a maximum value, and decreases continuously to a minimum value when the support section 3 is pivoted forwards and downwards. The maximum value is 180 degrees, for example.

As an example, the pivot angle 47 is defined as an angle between a support section axis 61 and a base section axis 62. The support section axis 61 extends in the longitudinal direction of the support section 3. In a state in which the user has put on the exoskeleton 20 and is standing upright, the support section axis 61 expediently extends vertically upwards. The base section axis 62 expediently represents a vertical axis of the base section 1 and extends vertically downwards, in particular in a vertical orientation of the base section 1, for example in a state in which the user has put on the exoskeleton 20 and is standing upright. As an example, the pivot angle 47 lies in a z-x plane.

The support section 3 comprises the main section and the textile carrying system, which is in particular detachably attached to the main section. By way of example, the main section serves to be worn on the back of the human body by means of the textile carrying system, in particular in a backpack-like manner. The support section 3, in particular the main section, comprises the back part 8, which is optionally elongated and which is optionally aligned with its longitudinal axis vertically and/or in the longitudinal direction of the user's back. Optionally, the longitudinal direction of the back part 8 extends along the longitudinal direction of the back.

The main section further comprises a force transmission element 18, in particular elongate and/or rigid, extending downwardly from the back part 8 towards the base section 1 to mechanically couple the back part 8 to the base section 1. The force transmission element 18 expediently serves to transmit a torque provided by the actuator device at the pivot axis 36 (which acts between the force transmission element 18 and the base section 1) to the back part 8, thereby providing a support force acting on the user's back. As an example, the back part 8 is tubular and/or backpack-shaped. The back part 8 is in particular rigid. In particular, the back part 8 comprises an expediently rigid back part housing, which is made, for example, from an in particular rigid plastic and/or as a hard shell. The back part 8 expediently serves to transmit a force from the force transmission element 18 to the user's back and/or to accommodate components for controlling and/or providing the support force.

By way of example, the textile carrying system has the back textile section 401, in particular a back mesh section, for abutment, in particular at least partial abutment, on the back of the user of the exoskeleton 20. In a state in which the exoskeleton 20 is attached to a user and the user assumes an upright posture, the back textile section 401 is, by way of example, displaced into a shape by the attachment to the main section, in which shape the back textile section 401 lies with an upper region 402 of the back textile section 401 against an upper back region of the user and, starting from the upper region 402, projects diagonally downwards away from the user's back, so that a lower region 403 of the back textile section 401 is spaced apart from the user's back. This is shown as an example in FIG. 20.

In a state in which the exoskeleton 20 is attached to the user and the user assumes a forwardly bent body posture, the back textile section 401 is further displaced, by way of example, by the attachment to the main section into a shape in which the back textile section 401, the upper region 402 and the lower region 403 of the back textile section 401 rest against the user's back. This is shown as an example in FIG. 21.

1. An exoskeleton, comprising:
a base section for attachment to a body section of the human body,
a support section movably coupled to the base section for supporting a body part of the human body,
an actuator device acting on the support section for providing a support force for the body part,
wherein the base section comprises a main section and a textile carrying system with which the base section is attachable to the body section, or wherein the support section comprises a main section and a textile carrying system with which the support section is attachable to the body section, namely a back of the human body, and
wherein the exoskeleton further comprises a carrying system attachment interface with which the textile carrying system is releasably attached to the main section.

2. The exoskeleton according to claim 1, wherein the textile carrying system has a back textile section for at least partial abutment against the back of a user of the exoskeleton.

3. The exoskeleton according to claim 2, wherein the back textile section is formed by the attachment to the main section into a shape in which, in a state in which the exoskeleton is attached to a user and the user assumes an upright posture, the back textile section abuts with an upper region of the back textile section on an upper back region of the user and, starting from the upper region, projects diagonally downwardly away from the user's back so that a lower region of the back textile section is spaced apart from the user's back.

4. The exoskeleton according to claim 3, wherein the back textile section is formed by the attachment to the main section into a shape in which, in a state in which the exoskeleton is attached to the user and the user assumes a forwardly bent posture, the upper region and the lower region of the back textile section abut on the user's back.

5. The exoskeleton according to claim 2, wherein the base section or the support section comprises a back part and the back textile section is stretched between an upper attachment point on the back part and a lower attachment point on the back part arranged below the first attachment point, such that the back textile section is spaced apart from the back part between the upper attachment point and the lower attachment point, and/or the back textile section is arranged on the main section such that the back textile section allows ventilation of the user's back.

6. The exoskeleton according to claim 2, wherein the back textile section is attached to the main section in such a way that the main section is adjustable in length without removing the back textile section from the main section.

7. The exoskeleton according to claim 2, wherein the length of the back textile section is adjustable to an upper body size of the user by adjusting a distance between a upper attachment point to which the back textile section is attached to the main section and a lower attachment point to which the back textile section is attached to the main section.

8. The exoskeleton according to claim 1, wherein the textile carrying system comprises a shoulder strap section and/or a pelvic strap section.

9. The exoskeleton according to claim 1 wherein the attachment interface comprises a safety fastening device via which the textile carrying system is attached to the main section, wherein at least two successive, mutually different release actuations of the safety fastening device are required to release the safety fastening device.

10. The exoskeleton according to claim 9, wherein the safety fastening device has a tab receptacle, a fastening tab inserted into the tab receptacle and a fastening bolt inserted into the fastening tab, wherein, in order to release the safety fastening device, as the first release actuation, a pulling of the fastening bolt out of the fastening tab and, as the second release actuation, a pulling of the fastening tab out of the tab receptacle is required.

11. The exoskeleton according to claim 9, wherein a closing actuation is required to close the safety fastening device, in which closing actuation the fastening tab is pushed into the tab receptacle and the fastening bolt thereby automatically moves into the fastening tab.

12. The exoskeleton according to claim 1, wherein the attachment interface comprises an additional fastening device with a hook and/or a lever lock.

13. The exoskeleton according to claim 1, wherein the attachment interface comprises a joint fastening device comprising a first joint section belonging to the textile carrying system and a second joint section belonging to the main section, wherein the first joint section and the second joint section form a joint between the textile carrying system and the main section, and the first joint section is detachable from the second joint section to release the joint fastening device.

14. The exoskeleton according to claim 13, wherein the joint fastening device has an actuating element and the first joint section is detachable from the second joint section via an actuation of the actuating element.

15. An arrangement, comprising an exoskeleton according to claim 1, wherein the textile carrying system is a first textile carrying system, further comprising a second textile carrying system, wherein the first textile carrying system is interchangeable with the second textile carrying system.

16. The arrangement according to claim 15, wherein the second textile carrying system differs from the first textile carrying system.

17. A method of operating an exoskeleton according to claim 1, comprising the step of:
detaching the textile carrying system from the main section.

18. A method of operating an arrangement according to claim 15, comprising the steps of:
removing the first textile carrying system from the main section,
attaching the second textile carrying system to the main section.

19. The exoskeleton according to claim 1, wherein the base section serves for attachment to the torso of a human body.

20. The exoskeleton according to claim 1, wherein the support section serves for supporting a limb of the human body.

21. The exoskeleton according to claim 1, wherein the support section serves for supporting an arm of the human body.

22. The exoskeleton according to claim 1, wherein the actuator device is a pneumatic actuator device.

23. The exoskeleton according to claim 2, wherein the back textile section comprises a back mesh section.

24. The exoskeleton according to claim 7, wherein the length of the back textile section is adjustable by adjusting the length of the main section.

25. The exoskeleton according to claim 14, wherein the actuating element is an actuating lever.

26. The arrangement according to claim 16, wherein the second textile carrying system differs from the first textile carrying system in its size and/or padding and/or material.
